(19) United States
(12) Patent Application Publication
(10) Pub. No.: US 2026/0196536 A1
(43) Pub. Date: Jul. 9, 2026

(54) FUEL CELL EXHAUST FLUID DRAIN REDUCTION

(71) Applicant: VOLVO TRUCK CORPORATION, Göteborg (SE)

(72) Inventors: Carl LÖWSTEDT, Onsala (SE); Vishal TULASIGERI, Dharwad (IN)

(73) Assignee: VOLVO TRUCK CORPORATION, Göteborg (SE)

(21) Appl. No.: 19/421,227

(22) Filed: Dec. 16, 2025

(30) Foreign Application Priority Data
Jan. 3, 2025 (SE) 2550002-6

(51) Int. Cl. H01M 8/04119; B60L 50/72; H01M 8/12

(52) U.S. Cl. CPC H01M 8/04156; B60L 50/72; H01M 2008/1293; H01M 2250/20

(57) ABSTRACT

An exhaust fluid drain reducer for an exhaust system arranged downstream a fuel cell system is described. The exhaust fluid drain reducer has an exhaust fluid inlet arranged in fluid communication with main exhaust piping of the exhaust system, the main exhaust piping fluidly connecting a fuel cell stack of the fuel cell system and a fluid exhaust chimney; an exhaust fluid outlet arranged in fluid communication with a fluid discharge location; and an exhaust fluid conduit fluidly connecting the exhaust fluid inlet and the exhaust fluid outlet. The exhaust fluid conduit is constructed with an inner diameter smaller than that of the main exhaust piping.

### TECHNICAL FIELD

The disclosure relates generally to a fuel cell technology. In particular aspects, the disclosure relates to fuel cell exhaust fluid drain reduction. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In contemporary fuel cell systems, the conversion of hydrogen into electricity generates significant amounts of exhaust fluids, including both water vapour and gases, that need to be managed. The present disclosure suggests improvements on how to manage these fuel cell exhaust fluids.

### SUMMARY

It is desirable to expel fuel cell exhaust fluids through relatively high vertical locations from a ground surface, such as an exhaust fluid chimney, rather than directly onto roads. This approach reduces the risk of water freezing on road surfaces, which can create hazardous driving conditions. Moreover, by expelling the fluids as high up as possible, particles will react to a greater extent with air, enhancing dispersion and reducing the concentration of pollutants.

However, expelling exhaust fluids at such a vertical height introduces challenges related to backpressure and inefficient water drainage. High backpressure can impede the smooth flow of fluids, potentially causing exhaust fluids to travel back toward the fuel cell stack. This backflow can damage critical components, such as membranes, leading to reduced performance or system failure.

It shall be noted that, while higher vertical expulsion of fluids is typically desirable, in some cases the fluids may be dispersed through a fluid exhaust chimney at other heights as well. For example, fluids may be expelled at intermediate or lower levels, depending on specific operational or environmental considerations.

In a first aspect of this disclosure there is provided an exhaust fluid drain reducer for an exhaust system arranged downstream of a fuel cell system, wherein the exhaust fluid drain reducer comprises an exhaust fluid inlet arranged in fluid communication with main exhaust piping of the exhaust system, the main exhaust piping fluidly connecting a fuel cell stack of the fuel cell system and a fluid exhaust chimney; an exhaust fluid outlet arranged in fluid communication with a fluid discharge location; and an exhaust fluid conduit fluidly connecting the exhaust fluid inlet and the exhaust fluid outlet, wherein the exhaust fluid conduit is constructed with an inner diameter smaller than that of the main exhaust piping.

The first aspect of the disclosure may seek to prevent backpressure and inefficient drainage in fuel cell systems. A technical benefit may include improving drainage and reducing backflow.

Optionally in some examples, including in at least one preferred example, the exhaust fluid drain reducer is arranged at a lower main exhaust piping portion. A technical benefit may include improved fluid capture and drainage efficiency due to gravity assistance.

Optionally in some examples, including in at least one preferred example, the lower main exhaust piping portion includes a lowest vertical position of the main exhaust piping, the exhaust fluid inlet being arranged at a predetermined distance from said lowest vertical position. A technical benefit may include improved fluid collection, reducing the risk of backflow.

Optionally in some examples, including in at least one preferred example, the predetermined distance is less than 5% of the total length of the main exhaust piping. A technical benefit may include enhanced fluid removal efficiency by reducing accumulation.

Optionally in some examples, including in at least one preferred example, a longitudinal axis of the main exhaust piping and the exhaust fluid drain reducer form a T-junction at the exhaust fluid inlet. A technical benefit may include effective diversion of fluids without disrupting the main flow.

Optionally in some examples, including in at least one preferred example, the exhaust fluid inlet comprises a lateral extension inside the main exhaust piping. A technical benefit may include increased fluid capture by directing flow into the reducer.

Optionally in some examples, including in at least one preferred example, the lateral extension is tilted by a tilt angle towards the longitudinal axis of the main exhaust piping. A technical benefit may include reduced turbulence and enhanced fluid directionality.

Optionally in some examples, including in at least one preferred example, the tilt angle is at least 160 degrees, more preferably 170 degrees, most preferably between 176 and 177 degrees. A technical benefit may include near-parallel alignment with the flow, improving capture efficiency.

Optionally in some examples, including in at least one preferred example, the lateral extension comprises an upper beveled edge. A technical benefit may include smoother fluid transition, reducing turbulence.

Optionally in some examples, including in at least one preferred example, the lateral extension comprises a lower grooved edge. A technical benefit may include improved fluid guidance and flow control.

Optionally in some examples, including in at least one preferred example, the lower grooved edge forms a cavity between the lateral extension and an inner surface of the main exhaust piping. A technical benefit may include enhanced fluid collection and direction.

Optionally in some examples, including in at least one preferred example, further comprising a connector framework comprising a first connector element affixed to a first main exhaust piping portion; a second connector element affixed to a second main exhaust piping portion; and an opening portion protruding downwards in relation to a longitudinal axis of the main exhaust piping, wherein the exhaust fluid inlet is received at the opening portion. A technical benefit may include secure connection and alignment of piping components.

Optionally in some examples, including in at least one preferred example, the connector framework is made of a material comprising silicone. A technical benefit may include increased flexibility and heat resistance.

Optionally in some examples, including in at least one preferred example, a portion of the main exhaust piping preceding and/or succeeding the arrangement of the exhaust fluid inlet in a flow direction of the exhaust system is constructed with an inner diameter smaller than that of other portions of the main exhaust piping. A technical benefit may include increased flow speed and pressure differential.

Optionally in some examples, including in at least one preferred example, the fluid discharge location is arranged vertically below the exhaust fluid drain reducer. A technical benefit may include gravity-assisted drainage, reducing fluid retention.

Optionally in some examples, including in at least one preferred example, the fluid discharge location is an exhaust fluid reservoir. A technical benefit may include temporary storage of fluids for controlled release.

Optionally in some examples, including in at least one preferred example, the exhaust fluid reservoir comprises an overflow valve enabling atmospheric ventilation for the exhaust fluid drain reducer. A technical benefit may include pressure regulation.

Optionally in some examples, including in at least one preferred example, the fluid discharge location is an external environment. A technical benefit may include direct expulsion of exhaust fluids, simplifying system design.

Optionally in some examples, including in at least one preferred example, the exhaust fluid outlet connects to a second conduit via which the exhaust fluid drain reducer connects to said fluid discharge location. A technical benefit may include flexible routing of exhaust fluids to various discharge points.

Optionally in some examples, including in at least one preferred example, the exhaust fluid conduit is constructed with an inner diameter being at least five times shorter than that of the main exhaust piping. A technical benefit may include optimized pressure dynamics for efficient fluid expulsion.

Optionally in some examples, including in at least one preferred example, comprising piping. A technical benefit may include structural support and guidance for fluid flow.

In a second aspect of this disclosure there is provided a fuel cell electric vehicle, comprising a fuel cell system and an exhaust system arranged downstream the fuel cell system and comprising the exhaust fluid drain reducer of the first aspect.

The second aspect of the disclosure may seek to prevent backpressure and inefficient drainage in fuel cell systems. A technical benefit may include improving drainage and reducing backflow.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary schematic illustration of a fuel cell electric vehicle according to an example.

FIG. 2 is an exemplary schematic illustration of a fuel cell system and an exhaust system according to an example.

FIG. 3 is an exemplary schematic illustration of a drain reducer arranged in an exhaust system for two fuel cell systems according to an example.

FIG. 4 is an exemplary schematic illustration of a drain reducer arranged in an exhaust system according to an example.

FIG. 5 is an exemplary schematic illustration of a drain reducer arranged in an exhaust system according to an example.

FIG. 6 is an exemplary schematic illustration of a drain reducer arranged in an exhaust system according to an example.

FIG. 7 is an exemplary schematic illustration of a drain reducer arranged in an exhaust system according to an example.

### DETAILED DESCRIPTION

The detailed description set forth below provides information and examples of the disclosed technology with sufficient detail to enable those skilled in the art to practice the disclosure.

The present disclosure addresses the need to expel fuel cell exhaust fluids through a fluid exhaust chimney, typically associated with higher vertical positions, to reduce the risk of water freezing on roads and enhance pollutant dispersion. To counter issues relating to backflow, the exhaust fluid drain reducer is designed to manage fluid flow efficiently. It connects an exhaust fluid inlet to the main exhaust piping, linking the fuel cell stack to the chimney. By using a conduit with a smaller inner diameter than the main exhaust piping, a pressure difference can be established, facilitating fluid movement towards the chimney. This design can ensure effective drainage and reduced backpressure, protecting the fuel cell stack from damage and enhancing system safety and performance. The facilitated fluid movement is applicable also for fluid exhaust chimneys not necessarily located at a high vertical position, as the increased fluid movement may be beneficial for directional flow in general.

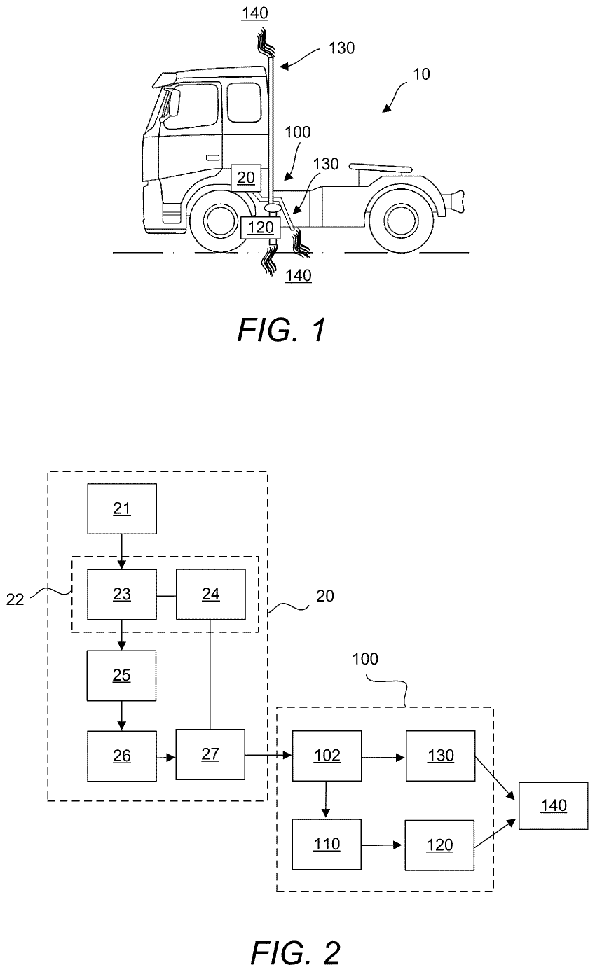

FIG. 1 is an exemplary schematic illustration of an FCEV 10. The FCEV 10 is illustrated as a heavy-duty vehicle, and can be realized as trucks, buses, construction equipment, or other vehicle types. The FCEV 10 comprises vehicle units and associated functionality as would be understood and expected by a skilled person, such as a powertrain, chassis, and various control systems.

The FCEV 10 comprises a fuel cell system 20 having a fuel cell stack with a plurality of fuel cells. The fuel cell system 20 is adapted to convert chemical energy stored in a fuel, typically hydrogen, as well as an oxidizing agent, typically oxygen or air, into electricity and heat as a byproduct through continuous electrochemical reactions. The generated electric current is used to power an electric motor for propulsion purposes, charge a vehicle battery, and/or power auxiliary vehicle systems of the FCEV 10. During the continuous electrochemical reactions, a reduction reaction occurs at the cathode where oxygen is supplied in combination with the protons and electrons from an external circuit. This reduction reaction generates exhaust gases which includes water vapour. Hereinafter, this will be referred to as exhaust fluids, and it shall be understood that the exhaust fluids includes both gas and water. The overall reaction discussed above can be represented according to the following: 2H₂+O₂→2H₂O+electricity+heat.

The present disclosure addresses how to manage these exhaust fluids. For hydrogen as the fuel to be consumed this is determined by the reaction above. Other fuels, such as methanol, ethanol, natural gas, propane, hydrocarbons, etc., involve their respective reactions generating exhaust fluids as a byproduct.

Purely for exemplary purposes, the following exemplary scenario describes how much water vapour that can be generated in an operation of a FCEV. The following assumptions are considered: A standard power rating for a fuel cell stack in a standard-size heavy duty FCEV may be 100 KW, a standard time of operation about one hour, and the fuel to be consumed is hydrogen having an approximate energy content of 286 kJ. The moles of hydrogen consumed may be calculated with the following formula:

$$\frac{Power * Time}{Energy content of hydrogen} = \frac{100 kW * 1 hour}{286 kJ / mol} \approx 0.349 moles .$$

With these assumptions, the volume of water vapour generated during one hour can be calculated as:

$$Volume of water vapour ( liters ) = Moles of hydrogen consumed * 22.4 \frac{liters}{mol} = 0.349 moles * 22.4 \frac{liters}{mol} = 7.81 liters .$$

Therefore, this particular standard-size heavy-duty FCEV with a 100 KW fuel cell stack, operating for one hour, would produce approximately 7.81 liters of water vapour as a byproduct of the electrochemical reactions. Clearly, longer operation times of the FCEV or higher power ratings of the fuel cell stack would result in a higher water vapour production. In addition to the water vapour, gas is generated, for example in the form of heat as discussed above.

The FCEV 10 further comprises an exhaust system 100 for fluids, connected downstream of the fuel cell system 20. The term “downstream” indicates the exhaust system 100 is positioned after the fuel cell system 20 in the flow path, receiving exhaust fluids from the fuel cell system 20. This setup allows the exhaust system 100 to channel away fluids in various ways that will be discussed in more detail herein.

The exhaust system 100 comprises a fluid discharge location, typically being an exhaust fluid reservoir 120, serving as an intermittent and temporary storage container for fluids before expulsion into an external environment 140. In this context, the “external environment 140” refers to the ambient atmosphere surrounding the FCEV 10, where exhaust fluids are expelled away from the interior of the FCEV 10. The exhaust fluid reservoir 120 allows for controlled release, ensuring that fluids are expelled in a manner that reduces excessive fluid release on driving surfaces and prevents fluid build-up within the exhaust system 100. The fluids in the exhaust fluid reservoir 120 is typically released at high vehicle speeds of the FCEV 10, or in workshop settings.

The exhaust system 100 also includes a fluid exhaust chimney 130, which is a structure designed to release larger amounts of fluids compared to the discharge location. The fluid exhaust chimney 130 is thus different from the fluid discharge location. The fluid exhaust chimney 130 is preferably arranged at a higher point above the FCEV 10. Typically, this is the highest point of the FCEV 10, or at least a point that is higher compared to the fuel cell system 20 or the fluid discharge location. This design not only aids in dispersing exhaust gases into the atmosphere more effectively, but also reduces the risk of exhaust fluids freezing on roads, which can occur if fluids are expelled at lower levels such as via the fluid discharge location. The fluid exhaust chimney 130 may accordingly assist in directing exhaust fluids upwards, reducing the chance of road hazards and improving environmental safety. This elevation helps in dispersing gases more widely, preventing localized accumulation and enhancing overall vehicle safety during operation.

As also visualized in FIG. 1, the fluid exhaust chimney 130 can in some cases be guiding the fluids through other conduits not necessarily being above the fuel cell system 20, into the external environment 140.

In view of the above, it is therefore typically desired to expel as much exhaust fluids as possible via the fluid exhaust chimney 130, preferably at a high vertical location, as this reduces the risk of road hazards caused by water and ice formation. However, this is not always possible due to limitations in pressure management and fluid dynamics within the exhaust system 100, which can lead to backpressure and inefficient drainage. These issues may result in fluid accumulation, potentially causing backflow into the fuel cell system 20 and risking damage to sensitive components. Hence, the following disclosure introduces an exhaust fluid drain reducer. This device will now be explained in a system context with further reference to FIG. 2.

FIG. 2 shows components of a fuel cell system 20 and an exhaust system 100 in more detail. The fuel cell system 20 comprises several interconnected components working together to manage air intake, compression, cooling, humidity adjustment, and electrochemical reactions. At the forefront is an air filter 21, responsible for cleansing incoming air to safeguard a fuel cell stack 27 from impurities. This filtered air is then directed to an electric turbocharger 22, including a compressor 23 and a turbine 24. The electric turbocharger 22 is arranged to manage air supply. The compressor 23 pressurizes and compresses the filtered air, enhancing electrochemical reaction efficiency within the fuel cell stack 27. Simultaneously, the turbine 24, driven by exhaust gases from the fuel cell stack 27, recovers energy to drive the compressor 23. In the process of compression within the electric turbocharger 22, the air experiences an increase in temperature. When air is compressed, its molecules are forced closer together, resulting in an increase in kinetic energy, which manifests as heat. This phenomenon may be described by Boyle's Law, which states that the pressure of a gas is inversely proportional to its volume when the temperature is held constant. Therefore, as the volume of air decreases during compression, its pressure and temperature increase.

Following compression, the heated compressed air passes through a charge air cooler 25 (often used interchangeably with intercooler in the context of fuel cell systems), where it undergoes cooling. Cooling is important for maintaining desirable operating conditions within the fuel cell stack 27. This cooling process may involve a dedicated coolant loop circulating through a pump, heat exchanger, and coolant fluid. The coolant absorbs heat from the heated compressed air within the charge air cooler 25.

Subsequently, the cooled and pressurized air proceeds to a humidifier 26, which adjusts its moisture content before entering the fuel cell stack 27. Proper humidity levels are important for efficient operation, particularly for certain types of fuel cells like Solid Oxide Fuel Cells (SOFCs). The humidifier 26 balances the moisture content using water vapor produced by the fuel cell stack 27 and introduced from the air supply system (i.e., the electric turbocharger 22 via the charge air cooler 25). Consequently, properly humidified air is delivered to the fuel cell stack 27 where the electrochemical reactions discussed above occur, converting fuel and oxidant into electricity and exhaust fluids including gas and water.

Downstream the fuel cell system 20, more specifically the fuel cell stack 27, is the exhaust system 100. The exhaust system 100 serves the purpose of managing and expelling exhaust fluids generated by the fuel cell system 20, more specifically the fuel cell stack 27 as a consequence of the reactions discussed above. Positioned “downstream” of the fuel cell system 20 means that the exhaust system 100 is situated in the flow path where fluids travel after leaving the fuel cell stack 27 before exiting the overall system, such as in the FCEV 10.

The exhaust system 100 comprises main exhaust piping 102, which includes one or more central conduits for expelling exhaust fluids from the fuel cell system 20. The main exhaust piping 102 is designed to accommodate varying configurations and materials, depending on the specific vehicle requirements and environmental conditions. The design of the main exhaust piping 102 can vary, reflecting differences in for example vehicle architecture and intended operational environments.

As discussed above, the exhaust system 100 includes several components for fluid expulsion into the external environment 140, being the fluid exhaust chimney 130, or another discharge location such as the exhaust fluid reservoir 120. As indicated in the schematic, the main exhaust piping 102 connects directly to the fluid exhaust chimney 130, and indirectly to the fluid reservoir 120 via an exhaust fluid drain reducer 110, before expelling fluids into the external environment 140.

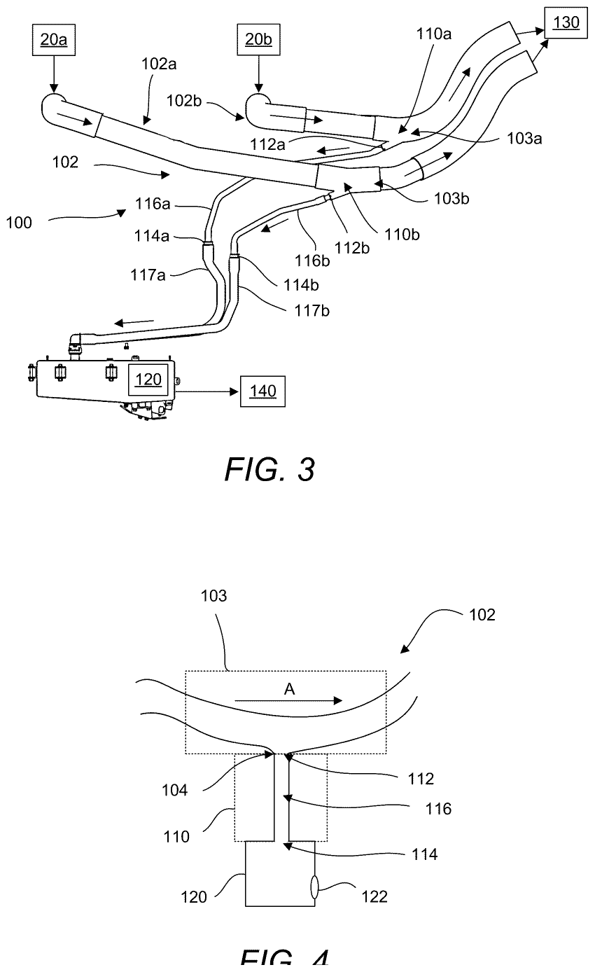

FIG. 3 shows the exhaust fluid drain reducer 110 arranged in an exhaust system 100. This particular exhaust system 100 is for two fuel cell systems 20a, 20b, although it shall be understood that it can be used for one or more fuel cell systems 20. Moreover, a single fluid exhaust chimney 130 and a single exhaust fluid reservoir 120 is employed, although any number may be suitable in various examples. The flow direction in the exhaust system 100 is indicated by way of arrows. Since this exhaust system 100 includes two fuel cell systems 20a, 20b, respective main piping conduits 102a, 102b extend from the fuel cell systems 20a, 20b to respective junctions where exhaust fluid drain reducers 110a, 110b are arranged. Other systems may include any suitable number of exhaust fluid drain reducers 110.

The exhaust fluid drain reducers 110a, 110b, more specifically exhaust fluid inlets 112a, 112b thereof, are in fluid communication with the main piping conduits 102a, 102b, the fluid exhaust chimney 130, and the discharge location, in this example being an exhaust fluid reservoir 120. This means that the exhaust fluid drain reducer 110 is connected in a way that allows the continuous flow of exhaust fluids between these components. The exhaust fluid drain reducer 110 includes piping arranged together with the main piping exhaust piping 102.

In addition to the exhaust fluid inlets 112a, 112b, each exhaust fluid drain reducer 110a, 110b comprises an exhaust fluid conduit 116a, 116b fluidly linking the exhaust fluid inlet 112a, 112b with a respective exhaust fluid outlet 114a, 114b.

In this example, the exhaust fluid outlets 114a, 114b connect to respective second conduits 117a, 117b. This allows fluids to travel from the main piping conduits 102a, 102b, via the exhaust fluid inlets 112a, 112b, through the exhaust fluid exhaust fluid conduit 116a, 116b, via the exhaust fluid outlets 114a, 114b, through the second conduits 117a, 117b, to the exhaust fluid reservoir 120. In other examples the exhaust fluid outlets 114a, 114b may connect directly to the exhaust fluid reservoir 120 without the use of second conduits 117a, 117b.

The exhaust fluid drain reducers 110a, 110b are designed with a narrower diameter compared to the main piping conduits 102a, 102b. This design leverages fluid dynamics principles to achieve desired performance. According to Bernoulli's Principle, lower diameter in the exhaust fluid drain reducers 110a, 110b increases the velocity of fluids in the main piping conduits 102a, 102b, which decreases static pressure within the exhaust system 100. This lower pressure facilitates the increased movement of fluids through the fluid exhaust chimney 130, effectively reducing road drainage and reducing the risk of ice formation (where the fluid exhaust chimney 130 is associated with a high vertical position as discussed herein). The Venturi Effect further enhances this process by creating a low-pressure zone within a constricted area where the exhaust fluid drain reducers 110a, 110b are arranged. This low pressure draws fluids into the main piping conduits 102a, 102b, ensuring it travels towards the fluid exhaust chimney 130. This movement not only prevents backflow into the fuel cell system 20 but also effectively drains the main piping conduits 102a, 102b.

Therefore, a narrower inner diameter in the exhaust fluid drain reducer 110 enhances system efficiency, and generally the narrower the more desired. However, there is still a balance to take into account between adequate drainage (via the exhaust fluid drain reducer 110) and effective fluid expulsion (via the fluid exhaust chimney 130). Preferably, the inner diameter of the exhaust fluid drain reducer 110 is at least five times smaller than that of the main exhaust piping 102. In a particular example, the exhaust fluid drain reducer 110 has an inner diameter of 10-12 mm and the main exhaust piping measures 76 mm, making it approximately 6-7 times larger.

The length of the exhaust fluid drain reducers 110a, 110b, and more specifically the length of the exhaust fluid conduits 116a, 116b may also be of relevance. The length should be long enough to allow the necessary pressure dynamics to occur, ensuring efficient fluid movement into the main exhaust stream. The longer the main piping conduit 102a, 102b, the longer the exhaust fluid drain reducers 110a, 110b should be, to maintain desirable pressure management and flow dynamics.

As seen in the illustration, the exhaust fluid drain reducers 110a, 110b are arranged at respective lower main exhaust piping portions 103a, 103b. This means that the exhaust fluid drain reducers 110a, 110b are positioned in a segment of main piping conduits 102a, 102b that is closest to the ground or the lowest vertical area in the horizontal plane of the piping layout. Specifically, the lower main exhaust piping portions 103a, 103b are located at an area where gravity causes exhaust fluids to naturally accumulate, such as at the bottommost curve or horizontal run of the main piping conduits 102a, 102b.

This positioning offers several advantages, especially in combination with the narrower inner diameter construction discussed above. Firstly, it effectively captures and drains accumulated fluids, preventing backflow into the fuel cell system 20, which could otherwise lead to damage and reduced efficiency. Secondly, positioning also utilizes gravity to enhance fluid removal. By reducing fluid buildup, the positioning can reduce the risk of corrosion and blockages, thereby maintaining desirable exhaust flow. Thirdly, this positioning limits the obstructions in the main exhaust flow of the main piping conduits 102a, 102b, which in turn may prevent temperature drops that could lead to condensation. Condensation is undesired because it can lead to blockages and corrosion within the exhaust system 100, reducing efficiency and potentially damaging components.

In FIG. 4, the exhaust fluid drain reducer 110 is depicted in greater detail, showing its connection to the lower main exhaust piping portion 103 of the main exhaust piping 102. The longitudinal axis A refers to the central line running along the length of the lower main exhaust piping portion 103, guiding the flow direction of fluids. The length of the lower main exhaust piping portion 103 along axis A can vary based on piping properties such as material type, thickness, and flexibility, as well as the specific curvature and diameter required for desired flow dynamics.

The exhaust fluid drain reducer 110 includes an exhaust fluid inlet 112, an exhaust fluid outlet 114, and an exhaust fluid conduit 116 linking the exhaust fluid inlet 112 with the exhaust fluid outlet 114 by fluid connection. The exhaust fluid inlet 112 is arranged in fluid communication with the main exhaust piping 102, and the exhaust fluid outlet 114 in fluid communication with the fluid discharge location, in this example being the exhaust fluid reservoir 120.

In this configuration, the longitudinal axis A of the lower main exhaust piping portion 103 intersects with the exhaust fluid drain reducer 110 at a T-junction, specifically at the exhaust fluid inlet 112. This T-junction design can allow for efficient fluid diversion by providing a direct path for purposes of draining the main exhaust piping 102. The T-junction shape may facilitate the separation of fluids from the main exhaust piping 102 without causing disruption to the flow. By positioning the exhaust fluid inlet 112 generally perpendicularly to the main exhaust piping 102, the exhaust fluid drain reducer 110 can capture fluids using gravitational force. It shall be noted that the T-junction is approximately T-shaped, meaning it does not need to form a 90-degree angle. Instead, it allows for variations in angles and configurations that still achieve the goal of effectively diverting fluids from the main exhaust piping 102 into the exhaust fluid drain reducer 102, ensuring flexibility in design while maintaining functionality.

The exhaust fluid reservoir 120 includes an overflow valve 122 for controlling pressure, thus connecting the exhaust fluid drain reducer 110 to atmospheric pressure through said overflow valve 122, enabling atmospheric ventilation. This creates a lower pressure at the exhaust fluid inlet 112, thus further contributing to the movement of fluids through the fluid exhaust chimney 130, with lower amount of fluid entering the exhaust fluid drain reducer 110 and flowing into the exhaust fluid reservoir 120.

As discussed above, the exhaust fluid drain reducer 110 may be arranged at a lower main exhaust piping portion 103. This may be realized by the lower main exhaust piping portion 103 including a lowest vertical position 104 of the main exhaust piping 102. Here, the exhaust fluid inlet 112 is arranged at a predetermined distance from said lowest vertical position 104, enhancing drainage efficiency and further preventing backflow. This can offer flexibility in design as it is the location of the exhaust fluid inlet 112 in relation to the lowest vertical position 104 that is the determining factor of where to arrange the exhaust fluid drain reducer 110.

The predetermined distance may vary depending on for example piping configurations and area of application. The predetermined distance may be than 5% of the total length of the main exhaust piping 102. This precise placement can ensure that the exhaust fluid drain reducer 110 effectively captures fluids without obstructing the main flow of fluids. Keeping the distance as low as possible can improve gravitational assistance in fluid removal, reducing the risk of fluid accumulation, corrosion, and blockages.

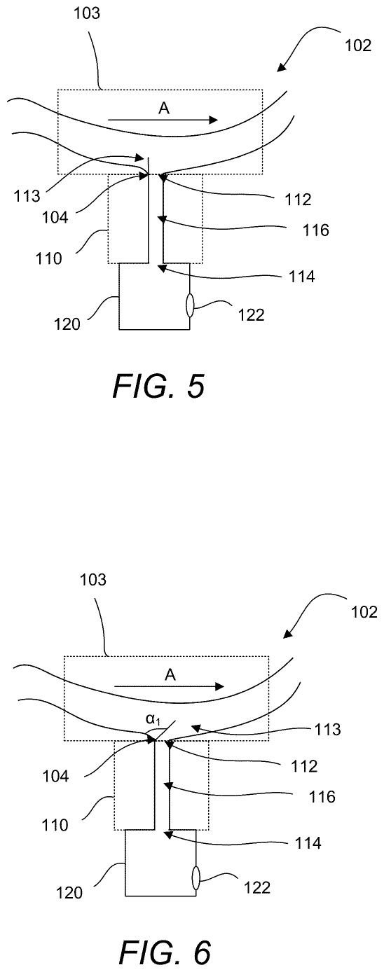

FIG. 5 is another exemplary exhaust fluid drain reducer 110. This example may include the details discussed above with reference to FIG. 4, and further incorporates a lateral extension 113 inside the main exhaust piping 102. The lateral extension 113 is a protrusion or additional section of the exhaust fluid inlet 112 extending sideways into the main exhaust piping 102. “Lateral” in these contexts means extending in a direction different from the flow direction, while “extension” indicates an added part. This lateral extension 113 can take various shapes, such as a tube or conduit, that projects into the main exhaust piping 102. The purpose of the lateral extension 113 is to capture and direct fluids into the exhaust fluid drain reducer 110, further preventing backflow of fluids into the fuel cell system 20.

FIG. 6 is another exemplary exhaust fluid drain reducer 110. This example may include the details discussed above with reference to FIG. 5, with the addition that the lateral extension 113 is tilted by a tilt angle α₁ towards the longitudinal axis A. This tilt is useful because it can align the lateral extension 113 more closely with the direction of the fluid flow, enhancing the capture of fluids into the exhaust fluid drain reducer 110, further preventing backflow of fluids into the fuel cell system 20. The angled orientation may also reduce turbulence and resistance since it can reduce the risk of drained fluids re-entering the main exhaust piping 102. Moreover, the tilt can further prevent backflow of fluids.

The tilt angle α₁ may be at least 160 degrees, preferably 170 degrees, and most advantageously between 176 and 177 degrees. Experiments conducted by the inventors showed that as the tilt angle approaches 176-177 degrees, the extension aligns more closely with the main exhaust flow at the lower main exhaust piping portion 103, enhancing fluid capture efficiency. This alignment which is near parallel with the axis A can reduce turbulence and backflow, ensuring smoother and more effective fluid movement into the exhaust fluid drain reducer 110, thereby improving the overall performance of the exhaust system 100.

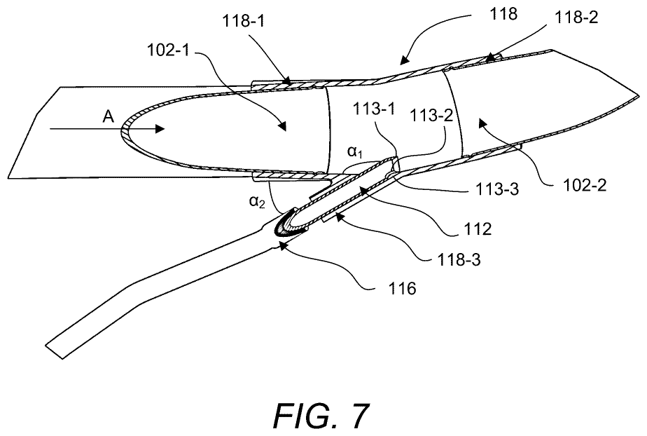

FIG. 7 is another exemplary exhaust fluid drain reducer 110, incorporating several advantageous examples of FIGS. 4-6 and adds yet advantageous features. In the examples of FIGS. 4-6 the lateral extension 113 included one side edge towards the fuel cell system 20 rather than towards the fluid exhaust chimney 130 (or an upper edge where the lateral extension 113 was tilted). Here, the lateral extension 113 includes not only an upper edge 113-1, but also a lower edge 113-2.

The upper edge 113-1 is beveled. The upper beveled edge 113-1 is an edge that has been shaped or cut at an angle other than 90 degrees, creating a sloping surface. This sloped transition contrasts with a square edge, where the two faces meet perpendicularly. The upper beveled edge 113-1 reduces the sharpness of the lateral extension 113. This design smoothens the transition of fluids entering the lateral extension 113, contrasting with a square edge that can create abrupt changes in flow direction. By reducing sharpness, the upper beveled edge 113-1 allows fluids to flow more seamlessly, reducing eddies and vortices that typically cause turbulence. Overall fluid dynamics can thereby be improved.

In addition, the peak or “nose tip” of the upper beveled edge 113-1 assists in creating a pressure differential within the exhaust system 100. As fluids flow over the upper beveled edge 113-1, the design facilitates a smoother transition, reducing static pressure at this point. This pressure differential aids in equalizing the internal pressure of the exhaust system 100 with atmospheric pressure. By doing so, it effectively channels the majority of the water towards the fluid exhaust chimney 130. This movement may harness the reduced pressure to overcome gravitational forces, ensuring efficient expulsion of fluids and reducing the risk of accumulation or backflow.

The angle of the bevel may vary, for instance 30°, 45°, or 60°, depending e.g. fluid velocity, piping configurations, power throughput mode of the area of application, or the like. The upper beveled edge 113-1 can either terminate in a sharp line or be rounded off to further reduce sharpness. The upper beveled edge 113-1 may include a single-sided bevel featuring a slope on one side of the upper beveled edge 113-1. The upper beveled edge 113-1 may include a double-sided bevel—often referred to as a chamfer—creating a symmetrical, V-shaped profile.

The lower edge 113-2 is grooved. The lower grooved edge 113-2 may include a series of linear indentations or channels cut into the surface. Unlike a smooth or flat edge, the grooved design provides pathways that help guide the fluid flow more precisely. These grooves can assist in channeling the fluids efficiently, reducing the likelihood of fluid scatter and enhancing directional flow. By providing a lower grooved edge 113-2, turbulence can therefore be reduced, and a more controlled fluid transition into the lateral extension 113 can be obtained, improving overall fluid dynamics.

The depth and spacing of the lower grooved edge 113-2 may vary, for instance, shallow or deep, narrow or wide, depending on factors such as fluid viscosity, pressure, and specific application requirements. The grooved edge 113-2 can be designed with parallel grooves for uniform flow or patterned variations to manage specific flow conditions. Additionally, the grooves can be angled to further influence flow direction or create a vortex effect if needed. The versatility in groove design allows for customization based on operational requirements.

In some examples, the lower grooved edge 113-2 forms a cavity 113-3 between the lateral extension 113 and an inner surface of the main exhaust piping 102. This cavity 113-3 may act as a collection area for fluids, allowing them to settle and be directed smoothly into the lateral extension 113. By creating this space, the cavity 113-3 can aid in reducing turbulence and promote a more organized flow pattern. The cavity 113-3 may also serve as a buffer zone, which can help in managing variations in fluid pressure and velocity.

The exhaust fluid drain reducer 110 further comprises a connector framework 118. The connector framework 118 secures the exhaust fluid drain reducer 110 in place within the exhaust system 100. The connector framework 118 comprises a first connector element 118-1 attached to a first section 102-1 of the main exhaust piping 102 and a second connector element 118-2 attached to the second section 102-2 of the main exhaust piping 102. The connector elements 118-1, 118-2 may include bolts, screws, adhesives, or other suitable fasteners. The connector framework 118 also includes an opening portion 118-3 extending downward relative to the longitudinal axis A. The opening portion 118-3 allows the exhaust fluid inlet 112 to be appropriately positioned for fluid capture and drainage.

A second tilt angle α2 is also shown in FIG. 7, between the exhaust fluid conduit 116 and the main exhaust piping 102. The second tilt angle α₂ refers to the angle at which the exhaust fluid conduit 116 is oriented relative to the longitudinal axis A. This angle complements the first tilt angle α₁, by further aligning the exhaust fluid conduit 116 with the natural flow of fluids, which may further enhance fluid capture and reducing turbulence. The second tilt angle α₂ may be selected based on the value of the first tilt angle, α₁. For example, if the longitudinal axis A is approximately parallel with a horizontal plane, the second tilt angle α₂ could be approximately 180-α₁.

The connector framework 118 may be made of a material comprising silicone, a material choice that offers flexibility, durability, and resistance to high temperatures typically prevalent in an exhaust system 100 for a fuel cell system 20.

In some examples, a portion of the main exhaust piping 102 may be designed with an inner diameter smaller than other sections of the main exhaust piping 102, either preceding (i.e., before) or succeeding (i.e., after) the arrangement of the exhaust fluid inlet 112 in the flow direction of the exhaust system 100. This design can offer flexibility, allowing the main exhaust piping 102 to be adapted in conjunction with the arrangement of the exhaust fluid drain reducer 110, for example based on a type of exhaust system and specific spatial constraints. By reducing the cross-section near the exhaust fluid drain reducer 110, either before and/or after its placement, the speed of the exhaust fluids can be increased, enhancing the pressure differential needed to increase fluid movement towards the fluid exhaust chimney 130.

While the main exhaust piping 102 in FIG. 7 is generally shown as having a consistent diameter, it can be tapered to meet design requirements. Tests conducted by the inventors have indicated that the inner diameter may be reduced by between approximately 15% to 33% if the total system pressure allows this. This tapering increases the flow speed near the exhaust fluid drain reducer 110, making the exhaust system 100 more efficient. Additionally, the narrower exhaust fluid drain reducer 110 should preferably be several decimeters long to effectively reduce static pressure, further facilitating fluid movement and improving performance.

The tapering described can also be applied to the connector framework 118, either as an alternative or in addition to the main exhaust piping 102. By reducing the diameter of the connector framework 118, the flow speed of the exhaust fluids can be increased. This increase in speed may further enhance the pressure differential such that fluids can more efficiently be directed towards the fluid exhaust chimney 130. Tapering the connector framework 118 may provides another layer of flexibility in the design.

In further examples of the disclosure the following is provided.
Example 1: An exhaust fluid drain reducer (110) for an exhaust system (100) arranged downstream of a fuel cell system (20), wherein the exhaust fluid drain reducer (110) comprises an exhaust fluid inlet (112) arranged in fluid communication with the main exhaust piping (102) of the exhaust system (100). The main exhaust piping (102) fluidly connects a fuel cell stack (27) of the fuel cell system (20) and a fluid exhaust chimney (130). An exhaust fluid outlet (114) is arranged in fluid communication with a fluid discharge location, and an exhaust fluid conduit (116) fluidly connects the exhaust fluid inlet (112) and the exhaust fluid outlet (114), wherein the exhaust fluid conduit (116) is constructed with an inner diameter smaller than that of the main exhaust piping (102).
Example 2: The exhaust fluid drain reducer (110) of Example 1, wherein the exhaust fluid drain reducer (110) is arranged at a lower main exhaust piping portion (103).
Example 3: The exhaust fluid drain reducer (110) of Example 2, wherein the lower main exhaust piping portion (103) includes a lowest vertical position (104) of the main exhaust piping (102), the exhaust fluid inlet (112) being arranged at a predetermined distance from said lowest vertical position (104).
Example 4: The exhaust fluid drain reducer (110) of any of Examples 1-3, wherein the predetermined distance is less than 5% of the total length of the main exhaust piping (102).
Example 5: The exhaust fluid drain reducer (110) of any of Examples 1-4, wherein a longitudinal axis (A) of the main exhaust piping (102) and the exhaust fluid drain reducer (110) form a T-junction at the exhaust fluid inlet (112).
Example 6: The exhaust fluid drain reducer (110) of Example 5, wherein the exhaust fluid inlet (112) comprises a lateral extension (113) inside the main exhaust piping (102).
Example 7: The exhaust fluid drain reducer (110) of Example 6, wherein the lateral extension (113) is tilted by a tilt angle (α₁) towards the longitudinal axis (A) of the main exhaust piping (102).
Example 8: The exhaust fluid drain reducer (110) of Example 7, wherein the tilt angle (α₁) is at least 160 degrees, more preferably 170 degrees, most preferably between 176 and 177 degrees.
Example 9: The exhaust fluid drain reducer (110) of any of Examples 6-8, wherein the lateral extension (113) comprises an upper beveled edge (113-1).
Example 10: The exhaust fluid drain reducer (110) of any of Examples 6-9, wherein the lateral extension (113) comprises a lower grooved edge (113-2).
Example 11: The exhaust fluid drain reducer (110) of Example 10, wherein the lower grooved edge (113-2) forms a cavity (113-3) between the lateral extension (113) and an inner surface of the main exhaust piping (102).
Example 12: The exhaust fluid drain reducer (110) of any of Examples 1-11, further comprising a connector framework (118) comprising a first connector element (118-1) affixed to a first main exhaust piping portion (102-1); a second connector element (118-2) affixed to a second main exhaust piping portion (102-2); and an opening portion (118-3) protruding downwards in relation to a longitudinal axis (A) of the main exhaust piping (102), wherein the exhaust fluid inlet (112) is received at the opening portion (118-3).
Example 13: The exhaust fluid drain reducer (110) of Example 12, wherein the connector framework (118) is made of a material comprising silicone.
Example 14: The exhaust fluid drain reducer (110) of any of Examples 1-13, wherein a portion of the main exhaust piping (102) preceding and/or succeeding the arrangement of the exhaust fluid inlet (112) in a flow direction of the exhaust system (100) is constructed with an inner diameter smaller than that of other portions of the main exhaust piping (102).
Example 15: The exhaust fluid drain reducer (110) of any of Examples 1-14, wherein the fluid discharge location is arranged vertically below the exhaust fluid drain reducer (110).
Example 16: The exhaust fluid drain reducer (110) of any of Examples 1-15, wherein the fluid discharge location is an exhaust fluid reservoir (120).
Example 17: The exhaust fluid drain reducer (110) of Example 16, wherein the exhaust fluid reservoir (120) comprises an overflow valve (122) enabling atmospheric ventilation for the exhaust fluid drain reducer (110).
Example 18: The exhaust fluid drain reducer (100) of any of Examples 1-17, wherein the exhaust fluid outlet (114) connects to a second conduit (117) via which the exhaust fluid drain reducer (100) connects to said fluid discharge location.
Example 19: The exhaust fluid drain reducer (110) of any of Examples 1-18, wherein the exhaust fluid conduit (116) is constructed with an inner diameter being at least five times shorter than that of the main exhaust piping (102).
Example 20: The exhaust fluid drain reducer (110) of any of Examples 1-19, comprising piping.
Example 21: A fuel cell electric vehicle (10) comprising a fuel cell system (20); and an exhaust system (100) arranged downstream of the fuel cell system (20) and comprising the exhaust fluid drain reducer (110) of any of Examples 1-20.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. An exhaust fluid drain reducer for an exhaust system arranged downstream a fuel cell system, wherein the exhaust fluid drain reducer comprises:
an exhaust fluid inlet arranged in fluid communication with main exhaust piping of the exhaust system, the main exhaust piping fluidly connecting a fuel cell stack of the fuel cell system and a fluid exhaust chimney;
an exhaust fluid outlet arranged in fluid communication with a fluid discharge location; and
an exhaust fluid conduit fluidly connecting the exhaust fluid inlet and the exhaust fluid outlet,
wherein the exhaust fluid conduit is constructed with an inner diameter smaller than that of the main exhaust piping.

2. The exhaust fluid drain reducer of claim 1, wherein the exhaust fluid drain reducer is arranged at a lower main exhaust piping portion.

3. The exhaust fluid drain reducer of claim 2, wherein the lower main exhaust piping portion includes a lowest vertical position of the main exhaust piping, the exhaust fluid inlet being arranged at a predetermined distance from said lowest vertical position.

4. The exhaust fluid drain reducer of claim 1, wherein the predetermined distance is less than 5% of the total length of the main exhaust piping.

5. The exhaust fluid drain reducer of claim 1, wherein a longitudinal axis of the main exhaust piping and the exhaust fluid drain reducer form a T-junction at the exhaust fluid inlet.

6. The exhaust fluid drain reducer of claim 1, wherein the exhaust fluid inlet comprises a lateral extension inside the main exhaust piping.

7. The exhaust fluid drain reducer of claim 6, wherein the lateral extension is tilted by a tilt angle towards the longitudinal axis of the main exhaust piping.

8. The exhaust fluid drain reducer of claim 7, wherein the tilt angle is at least 160 degrees.

9. The exhaust fluid drain reducer of claim 6, wherein the lateral extension comprises an upper beveled edge.

10. The exhaust fluid drain reducer of claim 6, wherein the lateral extension comprises a lower grooved edge.

11. The exhaust fluid drain reducer of claim 10, wherein the lower grooved edge forms a cavity between the lateral extension and an inner surface of the main exhaust piping.

12. The exhaust fluid drain reducer of claim 1, further comprising a connector framework comprising:
a first connector element affixed to a first main exhaust piping portion;
a second connector element affixed to a second main exhaust piping portion; and
an opening portion protruding downwards in relation to a longitudinal axis of the main exhaust piping, wherein the exhaust fluid inlet is received at the opening portion.

13. The exhaust fluid drain reducer of claim 12, wherein the connector framework is made of a material comprising silicone.

14. The exhaust fluid drain reducer of claim 1, wherein a portion of the main exhaust piping preceding and/or succeeding the arrangement of the exhaust fluid inlet in a flow direction of the exhaust system is constructed with an inner diameter smaller than that of other portions of the main exhaust piping.

15. The exhaust fluid drain reducer of claim 1, wherein the fluid discharge location is arranged vertically below the exhaust fluid drain reducer.

16. The exhaust fluid drain reducer of claim 1, wherein the fluid discharge location is an exhaust fluid reservoir.

17. The exhaust fluid drain reducer of claim 16, wherein the exhaust fluid reservoir comprises an overflow valve enabling atmospheric ventilation for the exhaust fluid drain reducer.

18. The exhaust fluid drain reducer of claim 1, wherein the exhaust fluid outlet connects to a second conduit via which the exhaust fluid drain reducer connects to said fluid discharge location.

19. The exhaust fluid drain reducer of claim 1, wherein the exhaust fluid conduit is constructed with an inner diameter being at least five times shorter than that of the main exhaust piping.

20. A fuel cell electric vehicle comprising:
a fuel cell system; and
an exhaust system arranged downstream the fuel cell system and comprising the exhaust fluid drain reducer of claim 1.
